(19) United States
(12) Patent Application Publication
(10) Pub. No.: US 2020/0088145 A1
(43) Pub. Date: Mar. 19, 2020

(54) FUEL STRAINER

(71) Applicant: GM GLOBAL TECHNOLOGY OPERATIONS LLC, DETROIT, MI (US)

(72) Inventors: William L. Villaire, Clarkston, MI (US); Edward J. Strzelecki, Oxford, MI (US); Manoj R. Chaudhari, Clinton Township, MI (US); Nicholas Girardi, Milford, MI (US)

(21) Appl. No.: 16/132,818

(22) Filed: Sep. 17, 2018

(51) Int. Cl. F02M 37/22

(52) U.S. Cl. CPC F02M 37/22; B01D 35/0273; F02M 2037/228

(57) ABSTRACT

An exemplary fuel filtering assembly includes a housing having a sidewall, a first surface, a strainer element, a first orifice, and a second orifice. The sidewall and the first surface define a fluid well. The strainer element is disposed in the fluid well and the first orifice and the second orifice are disposed in a channel defined by a first flow guidance member, a second flow guidance member, and a flow separating member. The first orifice is positioned at a first end of the channel and the second orifice is positioned at a second end of the channel opposite the first end and the first orifice is separated from the second orifice by the flow separating member.

The present invention relates generally to the field of vehicles and, more specifically, to an apparatus for filtering fuel.

Diesel powered vehicles generally include an inlet strainer as part of a fuel pump module return flow pathway to filter the diesel fuel prior to it being drawn back into the inlet of the low-pressure fuel pump. During cold weather operation, wax crystals can precipitate out of the fuel and plug the fuel strainer. During hot weather operation, the return fuel may be at a higher desired temperature than the fuel drawn into the fuel pump. Conventional strainers may be rendered ineffective by large amounts of wax buildup and for optimal operation it may be desired to reduce the temperature of the return fuel.

### SUMMARY

Embodiments according to the present disclosure provide a number of advantages. For example, embodiments according to the present disclosure enable better mixing of higher temperature fuel with fuel proximate to the strainer screen promoting quicker de-waxing of the lower temperature diesel fuel proximate to the screen during cold weather operation. Additionally, some embodiments according to the present disclosure enable better mixing of higher temperature return fuel flow with lower temperature fuel in the fuel reservoir prior to the fuel entering the fuel pump inlet during hot weather operation.

In one aspect, an automotive vehicle includes a body, an engine enclosed by the body, a fuel reservoir enclosed by the body, and a fuel pump assembly fluidly coupled to the engine and to the fuel reservoir. The fuel pump assembly includes a fuel pump and a strainer assembly. The strainer assembly includes a housing having a sidewall, a first surface, a strainer element, a first orifice, and a second orifice, the sidewall and the first surface defining a fluid well, the strainer element disposed in the fluid well, the first orifice and the second orifice disposed in a channel defined by a first flow guidance member, a second flow guidance member, and a flow separating member. The first orifice is positioned at a first end of the channel and the second orifice is positioned at a second end of the channel opposite the first end and the first orifice is separated from the second orifice by the flow separating member.

In some aspects, the flow separating member is a curved member such that a convex surface of the flow separating member is oriented toward the first orifice and a concave surface of the flow separating member is oriented toward the second orifice.

In some aspects, the flow separating member is positioned at the second end of the channel and is positioned between the first orifice and the second orifice.

In some aspects, the strainer assembly includes a plurality of strainer elements positioned adjacent to the sidewall.

In some aspects, fluid enters the strainer assembly via the first orifice and exits the strainer assembly via the second orifice and the first flow guidance member and the second flow guidance member direct fluid from the first orifice toward the sidewall of the housing and across the plurality of strainer elements.

In another aspect, a system for filtering a fluid includes a fuel pump assembly including a fuel pump and a strainer assembly. The strainer assembly includes a housing having a sidewall, a floor, a first surface, a strainer element, a first orifice, and a second orifice. The sidewall and the first surface define a fluid well, the strainer element is disposed in the fluid well, the first orifice and the second orifice are disposed in a channel defined by a first flow guidance member, a second flow guidance member, and a flow separating member. The first orifice is positioned at a first end of the channel and the second orifice is positioned at a second end of the channel opposite the first end and the first orifice is separated from the second orifice by the flow separating member.

In some aspects, the flow separating member is a curved member such that a convex surface of the flow separating member is oriented toward the first orifice and a concave surface of the flow separating member is oriented toward the second orifice.

In some aspects, the flow separating member is positioned at the second end of the channel and is positioned between the first orifice and the second orifice.

In some aspects, the strainer assembly includes a plurality of strainer elements positioned adjacent to the sidewall.

In some aspects, fluid enters the strainer assembly via the first orifice and exits the strainer assembly via the second orifice and the first flow guidance member and the second flow guidance member direct fluid from the first orifice toward the sidewall of the housing and across the plurality of strainer elements.

In yet another aspect, a fuel filtering assembly includes a housing having a sidewall, a first surface, a strainer element, a first orifice, and a second orifice. The sidewall and the first surface define a fluid well. The strainer element is disposed in the fluid well and the first orifice and the second orifice are disposed in a channel defined by a first flow guidance member, a second flow guidance member, and a flow separating member. The first orifice is positioned at a first end of the channel and the second orifice is positioned at a second end of the channel opposite the first end and the first orifice is separated from the second orifice by the flow separating member.

In some aspects, the flow separating member is a curved member such that a convex surface of the flow separating member is oriented toward the first orifice and a concave surface of the flow separating member is oriented toward the second orifice.

In some aspects, the flow separating member is positioned at the second end of the channel and is positioned between the first orifice and the second orifice.

In some aspects, the fuel filtering assembly further includes a plurality of strainer elements positioned adjacent to the sidewall.

In some aspects, fluid enters the assembly via the first orifice and exits the strainer assembly via the second orifice and the first flow guidance member and the second flow guidance member direct fluid from the first orifice toward the sidewall of the housing and across the plurality of strainer elements.

### BRIEF DESCRIPTION OF THE DRAWINGS

The present disclosure will be described in conjunction with the following figures, wherein like numerals denote like elements.

FIG. 1 is a schematic diagram of a vehicle having a fuel strainer assembly, according to an embodiment;

FIG. 2 is an inside perspective view of a fuel strainer assembly, according to an embodiment;

FIG. 3 is a view of one side of the fuel strainer assembly of FIG. 2, according to an embodiment; and

FIG. 4 is a view of the opposite side of the fuel strainer assembly of FIG. 2, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

A low-pressure fuel pump module typically includes a fuel strainer apparatus upstream of the fuel pump to strain return fuel, that is, fuel that is not consumed during the combustion process in the engine. Some diesel fuels contain wax crystals that can separate from the fuel and become trapped on the mesh strainer elements of the strainer apparatus. These wax crystals can form a waxy buildup on the strainer elements, resulting in decreased performance of the fuel strainer apparatus, particularly during cold weather operation. During hot weather operation, the return fuel may be at a higher temperature than the fuel contained within the fuel reservoir. The embodiments discussed herein promote improved mixing of the return fuel within the strainer apparatus. The improved mixing of warm return fuel with fuel proximate to the strainer elements promotes quicker de-waxing of the cold fuel around the strainer elements during cold weather operation. The improved mixing also promotes temperature equalization of hot return fuel with cooler fuel in the reservoir prior to the fuel being drawn into the fuel pump during hot weather operation.

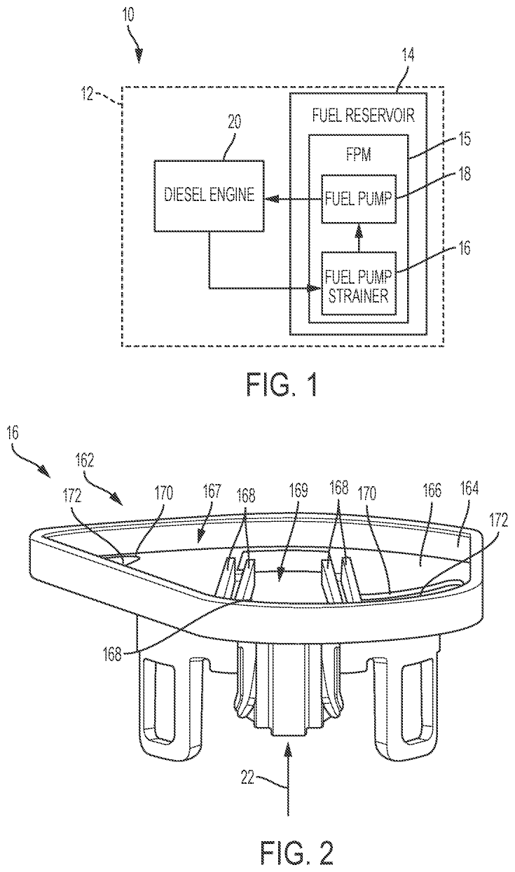

Referring to the drawings, where like reference numbers refer to like components, FIG. 1 illustrates a schematic depiction of a diesel-powered vehicle 10 according to an embodiment. The vehicle 10 includes a vehicle body 12 that encloses an engine 20, a fuel reservoir 14, and a fuel pump module (FPM) assembly 15. In some embodiments, the engine 20 is a diesel engine. The fuel pump module assembly 15 includes a strainer assembly 16 upstream of a fuel pump 18. In some embodiments, the FPM assembly 15 is enclosed within the fuel reservoir 14. In other embodiments, the FPM assembly 15 is separate from and fluidly connected to the fuel reservoir 14. Fuel from the fuel reservoir 14 is delivered to the engine 20 via the FPM assembly 15. Fuel that is not consumed by the engine 20 in the combustion process is returned to the strainer assembly 16 prior to being drawn into the fuel pump 18 for delivery to the engine 20.

With reference to FIGS. 2-4, one embodiment of the strainer assembly 16 is shown in more detail. FIG. 2 illustrates an inside, perspective view of the strainer assembly 16. The strainer assembly 16 includes a housing 162. The housing 162 includes a sidewall 164 and a surface 166 defining a well 167. The surface 166 is an approximately planar surface. The surface 166 of the well 167 includes a plurality of edges 170. The edges 170 define openings in the well 167 in which strainer elements 172 are disposed. In some embodiments, the strainer assembly 16 fits within the housing of the fuel pump 18. In other embodiments, the strainer assembly 16 is contained within a separate housing fluidly coupled to the fuel pump 18.

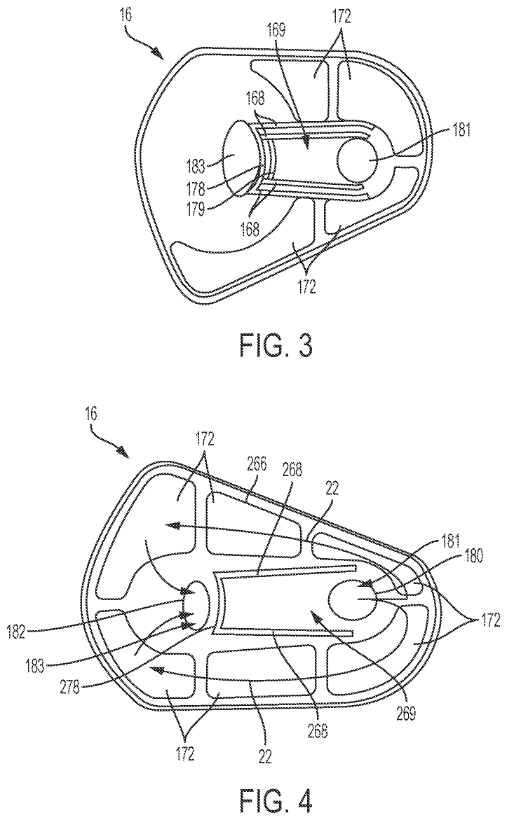

As shown in FIG. 3, the housing 162 also includes, in some embodiments, a plurality of flow guidance members or walls 168 that are approximately perpendicular to and extend from the surface 166. The plurality of flow guidance members 168 define a channel 169. The channel 169 has a first end and a second end opposite the first end. While two flow guidance members 168 are shown on each side of the channel 169 in FIGS. 2 and 3, it is understood that other embodiments may have one flow guidance member 168 on either side of the chancel 169.

The channel 169 is, in some embodiments, also defined by one or more flow separating members. The flow separating members 178, 179 are curved members positioned at the second end of the channel 169 opposite the first end. In some embodiments, each of the flow separating members 178, 179 is curved such that a concave surface of the each of the flow separating members 178, 179 is oriented toward a second orifice 183 defined by an edge in the surface 166. In some embodiments, a convex surface of each of the flow separating members 178, 179 is oriented toward a first orifice 181. Some embodiments include either the flow separating member 178 or the flow separating member 179. In some embodiments, the flow separating members 178, 179 are nested, arcuate members. In some embodiments, the flow separating members 178, 179 are integrally formed with the flow guidance members 168 to form a continuous, approximately U-shaped structure extending from the surface 166. In some embodiments, the flow separating members 178, 179 are separate from the flow guidance members 168.

In a preferred embodiment, fuel enters the housing 162 via a first orifice located at the first end of the channel 169 and leaves the housing 162, after passing over a plurality of straining elements, via a second orifice located at the second end of the channel 169 opposite the first end. Return fuel from the engine 20 passes through the housing 162 as shown by the arrows 22. The fuel is directed across the strainer elements 172. In some embodiments, the walls 168 direct the return fuel to the outer areas of the well 167, as shown in FIGS. 3 and 4. The placement of additional flow separators or walls direct the flow of fluid from the first orifice to the second orifice, as discussed in greater detail herein.

FIG. 4 is a view of the bottom of the strainer assembly 16. Similar to the view shown in FIG. 3, the strainer assembly 16 shown in FIG. 4 includes a surface 266 encircled by the sidewall 164. The surface 266 is an approximately planar surface. A plurality of flow guidance members 268 extend from the surface 266, shown in FIG. 4 as walls. The flow guidance members 268 define a channel 269. The channel 269 has a first end and a second end opposite the first end. The flow guidance members 268 direct fluid from the fluid entrance to the fluid exit such that the fluid passes over the plurality of strainer elements, as discussed in greater detail herein.

The channel 269 is, in some embodiments, also defined by a flow separating member 278, shown as a wall in FIG. 4. The flow separating member 278 is a curved member positioned at the second end of the channel 269 opposite the first end. In some embodiments, the flow separating member 278 is curved such that a convex surface of the flow separating member 278 is oriented toward a first orifice 181 defined by an edge 180 in the surface 266.

A second orifice 183 is defined by an edge 182 in the surface 266. The first orifice 181 and the second orifice 183 are preferably separated by the channel 269. In some embodiments, the first orifice 181 and the second orifice 183 are separated by a flow separating member, such as the flow separating member 278. In some embodiments, the flow separating member 278 is curved such that a convex surface of the flow separating member 278 is oriented toward the first orifice 181 and a concave surface of the flow separating member 278 is oriented toward the second orifice 183. In some embodiments, the flow separating member 278 is integrally formed with the flow guidance members 268 to form a continuous, approximately U-shaped structure extending from the surface 266. In some embodiments, the flow separating member 278 is separate from the flow guidance members 268.

Fluid, such as return diesel fuel from the engine 20, passes into the strainer assembly 16 via the first orifice 181. As illustrated by the arrows 22, the fluid is directed toward the outer wall 164 of the housing 162 and across the plurality of strainer elements 172 by the flow guidance members 268. The orientation and positions of the flow guidance members 268 and the flow separating member 278 direct the entering fluid away from the second orifice 183 such that the fluid is circulated within the housing 162. As shown in FIG. 4, the plurality of strainer elements 172 are primarily positioned adjacent to the wall 164 of the housing 162, that is, generally near the periphery of the housing 162, such that as the fluid is circulated within the housing 162, the fluid passes over the plurality of strainer elements 172 prior to exiting the housing 162 via the second orifice 183.

During cold weather operation, as fluid passes over the strainer elements 172, the higher temperature of the return fluid mixing with the comparatively lower temperature fuel results in improved mixing of the fuel proximate to the strainer assembly 16 and de-waxing of the strainer elements 172. Additionally, in some embodiments, during hot weather operation, the temperature of the return fuel entering the strainer assembly 16 is reduced due to the lower temperature of the fuel in the surrounding fuel reservoir.

It is understood that the embodiment shown in FIGS. 2-4 is one embodiment of a fuel strainer assembly. Other embodiments of a fuel strainer assembly that direct fluid across a plurality of strainer elements may have a different shape, orientation and number of the flow guidance members, orientation and number of the flow separating members, location of one or more of the orifices, location of one or more of the strainer elements, etc., for example and without limitation.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment,

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may he approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a. range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5. but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about .5,” “1 to 3,” “2 to 4,” “3 to 5,” etc. This same principle applies to ranges reciting only one numerical -value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle, comprising:
a body;
an engine enclosed by the body;
a fuel reservoir enclosed by the body; and
a fuel pump assembly fluidly coupled to the engine and to the fuel reservoir, the fuel pump assembly comprising a fuel pump and a strainer assembly, the strainer assembly comprising a housing having a sidewall, a first surface, a strainer element, a first orifice, and a second orifice, the sidewall and the first surface defining a fluid well, the strainer element disposed in the fluid well, the first orifice and the second orifice disposed in a channel defined by a first flow guidance member, a second flow guidance member, and a flow separating member;
wherein the first orifice is positioned at a first end of the channel and the second orifice is positioned at a second end of the channel opposite the first end and the first orifice is separated from the second orifice by the flow separating member.

2. The automotive vehicle of claim 1, wherein the flow separating member is a curved member such that a convex surface of the flow separating member is oriented toward the first orifice and a concave surface of the flow separating member is oriented toward the second orifice.

3. The automotive vehicle of claim 1, wherein the flow separating member is positioned at the second end of the channel and is positioned between the first orifice and the second orifice.

4. The automotive vehicle of claim 1, wherein the strainer assembly comprises a plurality of strainer elements positioned adjacent to the sidewall.

5. The automotive vehicle of claim 4, wherein fluid enters the strainer assembly via the first orifice and exits the strainer assembly via the second orifice and the first flow guidance member and the second flow guidance member direct fluid from the first orifice toward the sidewall of the housing and across the plurality of strainer elements.

6. A system for filtering a fluid, comprising a fuel pump assembly comprising a fuel pump and a strainer assembly, the strainer assembly comprising a housing having a sidewall, a floor, a first surface, a strainer element, a first orifice, and a second orifice, the sidewall and the first surface defining a fluid well, the strainer element disposed in the fluid well, the first orifice and the second orifice disposed in a channel defined by a first flow guidance member, a second flow guidance member, and a flow separating member, wherein the first orifice is positioned at a first end of the channel and the second orifice is positioned at a second end of the channel opposite the first end and the first orifice is separated from the second orifice by the flow separating member.

7. The system of claim 6, wherein the flow separating member is a curved member such that a convex surface of the flow separating member is oriented toward the first orifice and a concave surface of the flow separating member is oriented toward the second orifice.

8. The system of claim 6, wherein the flow separating member is positioned at the second end of the channel and is positioned between the first orifice and the second orifice.

9. The system of claim 6, wherein the strainer assembly comprises a plurality of strainer elements positioned adjacent to the sidewall.

10. The system of claim 9, wherein fluid enters the strainer assembly via the first orifice and exits the strainer assembly via the second orifice and the first flow guidance member and the second flow guidance member direct fluid from the first orifice toward the sidewall of the housing and across the plurality of strainer elements.

11. A fuel filtering assembly, comprising a housing having a sidewall, a first surface, a strainer element, a first orifice, and a second orifice, the sidewall and the first surface defining a fluid well, the strainer element disposed in the fluid well, the first orifice and the second orifice disposed in a channel defined by a first flow guidance member, a second flow guidance member, and a flow separating member, wherein the first orifice is positioned at a first end of the channel and the second orifice is positioned at a second end of the channel opposite the first end and the first orifice is separated from the second orifice by the flow separating member.

12. The assembly of claim 11, wherein the flow separating member is a curved member such that a convex surface of the flow separating member is oriented toward the first orifice and a concave surface of the flow separating member is oriented toward the second orifice.

13. The assembly of claim 11, wherein the flow separating member is positioned at the second end of the channel and is positioned between the first orifice and the second orifice.

14. The assembly of claim 11, further comprising a plurality of strainer elements positioned adjacent to the sidewall.

15. The assembly of claim 14, wherein fluid enters the assembly via the first orifice and exits the strainer assembly via the second orifice and the first flow guidance member and the second flow guidance member direct fluid from the first orifice toward the sidewall of the housing and across the plurality of strainer elements.
